(19) United States
(12) Patent Application Publication
(10) Pub. No.: US 2020/0043716 A1
(43) Pub. Date: Feb. 6, 2020

(54) METHOD FOR DESIGNING ION OPTICAL ELEMENT AND MASS SPECTROMETRY DEVICE

(71) Applicant: SHIMADZU CORPORATION, Kyoto-shi, Kyoto (JP)

(72) Inventor: Junichi TANIGUCHI, Kyoto-shi, Kyoto (JP)

(73) Assignee: SHIMADZU CORPORATION, Kyoto-shi, Kyoto (JP)

(21) Appl. No.: 16/606,815

(22) PCT Filed: Jul. 24, 2017
(86) PCT No.: PCT/JP2017/026610

§ 371 Date: Oct. 21, 2019

(51) Int. Cl. H01J 49/42

(52) U.S. Cl. CPC H01J 49/4225; H01J 49/4215

(57) ABSTRACT

In a linear ion trap (3), the shape and arrangement of four rod electrodes (3a-3d) are made to deviate from an ideal state in which only a quadrupole electric field is created, in such a manner that so that the polarity of the ratio of the strength of an octapole electric field to the strength of the quadrupole electric field is different from the polarity of the ratio of the strength of an dodecapole electric field to the strength of the quadrupole electric field, where the absolute value of each of the ratios is equal to or greater than 0.005, and the absolute value of the ratio of the strength of the octapole electric field to the strength of the dodecapole electric field is within a range from 0.5 to 1.4. By superposing the octapole electric field on the quadrupole electric field and additionally superposing the dodecapole electric field having the opposite polarity to the octapole electric field, a peak shift of a resonance curve can be canceled and a peak having a steep edge on both high-frequency and low-frequency sides can be obtained. A linear ion trap satisfying those conditions can achieve both high ion-trapping efficiency and high ion-separating power.

### TECHNICAL FIELD

The present invention relates to a method for designing an ion optical element for trapping ions or selecting specific ions by the effect of a radio-frequency electric field, as well as a mass spectrometer using such an ion optical element. The present invention particularly relates to a method for designing an ion optical element using quadrupole rod electrodes, such as a linear ion trap or quadrupole mass filter, as well as a mass spectrometer using such an ion optical element.

### BACKGROUND ART

A mass spectrometer which uses an ion trap for trapping ions by the effect of an electric field is commonly known as a type of mass spectrometer. Ion traps are roughly divided into a three-dimensional quadrupole ion trap and a linear ion trap (which may also be called the “two-dimensional ion trap”). A common type of linear ion trap includes four rod electrodes arranged substantially parallel to each other so as to surround a straight central axis. Ions are trapped within the space surrounded by those four rod electrodes (see Patent Literature 1).

FIG. 2 is a schematic sectional view of the four rod electrodes 3a, 3b, 3c and 3d in a linear ion trap at a plane orthogonal to the central axis C. The four rod electrodes 3a-3d each have a circular cross section and are arranged so as to be in contact with an outer surface of a virtual cylinder having a predetermined radius x₀ centered on the central axis, where every two rod electrodes neighboring each other (e.g. 3a and 3b) make a rotational angle of 90 degrees around the central axis C. When ions are to be trapped within the space surround by the four rod electrodes 3a-3d, radio-frequency voltages having the same amplitude and opposite phases (with a phase difference of 180 degrees) are respectively applied to each pair of the rod electrodes neighboring each other in the circumferential direction. A trapping electric field is thereby created within the space surrounded by the rod electrodes.

When the trapped ions are to be excited and ejected from the linear ion trap, or when the ions are to be made to collide with neutral particles (e.g. gas molecules) introduced into the inner space to promote their fragmentation by collision induced dissociation, alternating voltages having the same amplitude and different polarities are respectively applied to two rod electrodes (e.g. 3a and 3c) facing each other across the central axis C, in such a manner that the alternating voltages are superposed on the aforementioned voltages for creating the trapping electric field. An electric field for resonantly exciting an ion having a specific mass-to-charge ratio (m/z) or ions included within a predetermined m/z range is thereby created within the space surrounded by the rod electrodes 3a-3d.

In the previously described linear ion trap, if the rod electrodes are shaped and arranged as theoretically computed, only the quadrupole electric field is created as the radio-frequency electric field within the inner space of the ion trap. However, in some cases, the shape and/or arrangement of the rod electrodes may intentionally be made to deviate from the theoretical state in order to improve the performance (for example, see Patent Literature 2). Making the shape and/or arrangement of the rod electrodes different from the ideal state gives rise to not only the quadrupole electric field but also a multipole electric field whose order is higher than the quadrupole (electric fields having higher orders than the quadrupole are hereinafter generally called the “multipole” electric field).

For example, consider the case where an octapole electric field is added to the quadrupole electric field. When the voltage applied to the rod electrodes is continuously varied while ions are trapped within the inner space, the ejection of the ions from the inner space to the outside begins at a specific voltage more suddenly than in the case where there is only the quadrupole electric field. This phenomenon can be utilized to improve the mass-resolving power in a mass spectrometer which uses a linear ion trap as the mass spectrometer (such a mass spectrometer is hereinafter called the “ion trap mass spectrometer”). The octapole electric field can also improve the ion-trapping efficiency within the inner space and thereby enhance detection sensitivity. In order to obtain such effects, conventionally available linear ion traps are often configured to use a multipole electric field, like the previously mentioned ones.

### CITATION LIST

### Patent Literature

Patent Literature 1: U.S. Pat. No. 6,797,950 B
Patent Literature 2: JP 2010-520605 A
Patent Literature 3: JP 2007-80830 A
Patent Literature 4: U.S. Pat. No. 5,449,905 B

### Non Patent Literature

Non Patent Literature 1: L. D. Landau and another author, “Mechanics”, Pergamon Press, 1969

### SUMMARY OF INVENTION

### Technical Problem

In the case where an MSⁿ analysis (where n is an integer equal to or greater than two) is performed in an ion trap mass spectrometer, after ions derived from a target sample have been trapped within the inner space, it is necessary to perform a precursor-ion selecting operation to discharge unnecessary ions to the outside except for an ion having a target m/z value, followed by collision induced dissociation or a similar process to dissociate an ion having the target nm/z value (precursor ion) retained within the ion trap. For the precursor-ion selecting operation, a technique as shown in FIG. 10 is commonly used in which the so-called FNF (filtered noise field) signal, which is a broadband signal whose frequency spectrum has a notch at the frequency corresponding to the target m/z, is applied to the rod electrodes as the excitation voltage (see Patent Literature 4).

As noted earlier, the ion-trapping efficiency improves when a multipole electric field is generated by intentionally making the shape and/or arrangement of the rod electrodes deviate from the ideal state. However, if the difference from the ideal state is equal to or larger than a certain extent, the resolving power of the ion separation for the precursor-ion selection by the previously described technique deteriorates, although the ion-trapping efficiency improves. If the resolving power of the ion separation is lowered, product-ion peaks originating from unwanted ions other than the target ion will appear in the MSⁿ spectrum, which leads to a deterioration in the quality of the MSⁿ spectrum. Due to such a restriction, it has been common practice that the difference in the shape and/or arrangement of the rod electrodes from the ideal state be limited within an appropriate, empirically determined range in an ion trap mass spectrometer for performing MSⁿ analyses. That is to say, in conventional ion trap mass spectrometers, efforts have not always been made to optimize the design for achieving the highest possible level of ion-trapping efficiency while maintaining a high level of the resolving power of the ion separation. Therefore, in practice, either the resolving power of the ion separation or the ion-trapping efficiency has been sacrificed so far.

At least one aspect of the present invention has been developed to solve the previously described problem and provide a method for designing an ion optical element which can improve ion-trapping efficiency while securing a high level of resolving power in the ion separation to create a high-quality MSⁿ spectrum as well as improve detection sensitivity. The present invention also provides a mass spectrometer using an ion optical element designed by such a method.

### Solution to Problem

Regardless of whether a linear type or three-dimensional quadrupole type of ion trap is used, the resolving power of the ion-separating operation using a radio-frequency electric field for ions trapped within the ion trap corresponds to the shape of the resonance curve which represents the relationship between the forced oscillation frequency of the ion and the oscillation amplitude of the ion in the radio-frequency electric field. As is commonly known, when the radio-frequency electric field created by the ion trap is a pure quadrupole electric field, i.e. in the case of an ideal state, the shape of the resonance curve will typically be a bell-like symmetrical peak, as shown in FIG. 4A. By comparison, as described in Patent Literature 3, when an octapole electric field is added to a quadrupole electric field, the resonance curve will be asymmetrical, for example, as shown in FIG. 4B, and the slope on either the low-frequency side or high-frequency side becomes steeper. Such a steeper slope means a sharper state of resonance, so that the resonance resolving power, i.e. the resolving power of the ion separation, will also be higher.

However, as is also the case with the example described in Patent Literature 3, if the slope on one side of the peak becomes steeper, the slope on the other side conversely becomes gentler. Therefore, if an ion having a specific m/z value or ions within a specific m/z range need to be selectively retained within the ion trap, the resolving power on the side with the gentler slope, i.e. on either the lower m/z side or higher m/z side, will be deteriorated, so that ions within a wider m/z range than the desired m/z value or m/z range will remain within the ion trap.

In view of this problem, the present inventor has conducted simulation calculations of the strength of a multipole electric field and resonance curve for various shapes and arrangements of the electrodes in an ion trap. The calculated results revealed that the slope of the resonance curve will be comparatively steep on both sides if the following conditions are satisfied: a dodecapole electric field whose order is even higher is additionally superposed on the octapole electric field which is superposed on the quadrupole electric field; the octapole electric field and the dodecapole electric field have opposite polarities (whether they strengthen or weaken the electric field); and the ratios of the strengths of the octapole electric field and the dodecapole electric field to that of the quadrupole electric field are roughly equal to each other and satisfy specific conditions. In other words, by making the shape and/or arrangement of the electrodes deviate from the ideal state so that the strengths of the octapole electric field and the dodecapole electric field superposed on the quadrupole electric field satisfy specific conditions, it is possible to improve the resolving power for the ion separation while maintaining the ion-trapping efficiency at a high level. The present inventor has completed the present invention based on such findings.

A method for designing an ion optical element according to the present invention is a method for designing an ion optical element including four rod electrodes arranged substantially parallel to a linear axis so as to surround the axis, the ion optical element allowing voltages to be respectively applied to the four rod electrodes to create a quadrupole electric field and a multipole electric field whose order is higher than the quadrupole electric field within a space surrounded by the rod electrodes, to trap ions within the space and subsequently perform an ion-separating operation for retaining an ion having a specific mass-to-charge ratio or ions included within a specific mass-to-charge-ratio range among the trapped ions by removing the other ions, or to perform an ion-separating operation for selectively allowing an ion having a specific mass-to-charge ratio or ions included within a specific mass-to-charge-ratio range to pass through among ions entering the space. The method is characterized in that the shape and arrangement of the four rod electrodes are determined so that the polarity of the ratio of the strength of an octapole electric field to the strength of a quadrupole electric field is different from the polarity of the ratio of the strength of an dodecapole electric field to the strength of the quadrupole electric field, where the absolute value of each of the ratios is equal to or greater than 0.005, and the absolute value of the ratio of the strength of the octapole electric field to the strength of the dodecapole electric field is within a range from 0.5 to 1.4.

The “ion optical element” in the present invention is typically a linear ion trap or quadrupole mass filter. It may also include other types of devices, such as an ion guide having an ion-trapping function.

In the context of a theoretical calculation, the “strength” of the quadrupole, octapole or other electric fields is the “value of a multipole electric field coefficient (or multipole field expansion coefficient)” in an expansion equation, such as equation (1) expressing the potential distribution within a space where an electric field is created (this equation will be described later). The “ratio” of the strength of an electric field is the ratio of the multipole electric field coefficient.

In a specific mode of the method for designing an ion optical element according to the present invention, the octapole electric field and the dodecapole electric field are generated and superposed on the quadrupole electric field by designing the four rod electrodes so that each of the four rod electrodes has a circular cross section or includes a portion having an arc-shaped cross section facing the axis, the four rod electrodes are grouped into two rod-electrode pairs each of which includes two rod electrodes facing each other across the axis, and the shortest distance between the axis and the two rod electrodes included in one rod-electrode pair is made to deviate from the shortest distance between the axis and the two rod electrodes included in the other rod-electrode pair.

A mass spectrometer according to one aspect of the present invention is a mass spectrometer using a linear ion trap designed by the method for designing an ion optical element according to the present invention. The mass spectrometer includes: an ion source configured to generate ions originating from a sample; a linear ion trap including four rod electrodes arranged substantially parallel to a linear axis so as to surround the axis, the linear ion trap allowing voltages to be respectively applied to the four rod electrodes to create a quadrupole electric field and a multipole electric field whose order is higher than the quadrupole electric field within a space surrounded by the rod electrodes, to trap ions within the space; and an ion detector section configured to detect an ion ejected from the linear ion trap, where the mass spectrometer is configured to trap ions within the space and subsequently perform an ion-separating operation for maintaining an ion having a specific mass-to-charge ratio or ions included within a specific mass-to-charge-ratio range among the trapped ions by removing the other ions,

where:

the shape and arrangement of the four rod electrodes in the linear ion trap are determined so that the polarity of the ratio of the strength of an octapole electric field to the strength of a quadrupole electric field is different from the polarity of the ratio of the strength of an dodecapole electric field to the strength of the quadrupole electric field, the absolute value of each of the ratios is equal to or greater than 0.005, and the absolute value of the ratio of the strength of the octapole electric field to the strength of the dodecapole electric field is within a range from 0.5 to 1.4.

The resonance curves shown in FIGS. 4A-4C are obtained in the case where a sinusoidal voltage of a single frequency is applied to the electrodes forming an ion trap. By this method, an ion having a specific oscillation frequency can be selectively excited or ejected from the space surrounded by the rod electrodes. On the other hand, as noted earlier, if an FNF signal having a notch at a specific oscillation frequency is applied to the electrodes forming the ion trap, an ion having a specific mass-to-charge-ratio value or ions included within a specific mass-to-charge-ratio range are selectively excluded from the excitation, while the other ions are all excited and significantly oscillated. By using this phenomenon, it is possible to realize a quadrupole type of mass filter which allows only an ion having a specific mass-to-charge-ratio value or ions included within a specific mass-to-charge-ratio range to pass through.

That is to say, a mass spectrometer according to another aspect of the present invention is a mass spectrometer including: an ion source configured to generate ions originating from a sample; a quadrupole mass filter configured to selectively allow an ion having a specific mass-to-charge ratio or ions included within a specific mass-to-charge-ratio range to pass through; and an ion detector section configured to detect an ion exiting from the quadrupole mass filter, where

the quadrupole mass filter includes four rod electrodes arranged substantially parallel to a linear axis so as to surround the axis, where the shape and arrangement of the four rod electrodes surrounding the axis are determined so that the polarity of the ratio of the strength of an octapole electric field to the strength of a quadrupole electric field is different from the polarity of the ratio of the strength of an dodecapole electric field to the strength of the quadrupole electric field, the absolute value of each of the ratios is equal to or greater than 0.005, and the absolute value of the ratio of the strength of the octapole electric field to the strength of the dodecapole electric field is within a range from 0.5 to 1.4; and

the mass spectrometer further includes a voltage generator configured to apply, to each of the four rod electrodes, a radio-frequency voltage having a frequency component corresponding to a mass-to-charge ratio or mass-to-charge-ratio range of an ion or ions which should be allowed to pass through the quadrupole mass filter.

Unlike the mass spectrometer according to the previous aspect of the present invention, the mass spectrometer according to this aspect of the present invention does not trap ions within the space surrounded by the rod electrodes, but excites and removes all ions except for an ion having a specific mass-to-charge-ratio value or ions included within a specific mass-to-charge-ratio range while ions are passing through the space. By determining the strengths of the quadrupole electric field, octapole electric field and dodecapole electric field so as to satisfy the previously described relationship, the slope of the resonance curve can be comparatively steep on both sides. Therefore, an ion or ions having a target mass-to-charge ratio or included within a target mass-to-charge-ratio range to be analyzed can be selectively allowed to pass through with a high level of resolving power.

In particular, the phenomenon that the slope of the resonance curve becomes comparatively steep on both sides can also be observed even when the degree of vacuum is comparatively low. i.e. when there is a comparatively large amount of residual gas. Commonly used quadrupole mass filters cannot sufficiently exhibit their performance unless the degree of vacuum is so high that the collision between the ions and gas is practically negligible. By comparison, the quadrupole mass filter in the mass spectrometer according to the previously described aspect of the present invention can exhibit a high level of ion-separating power even at a lower degree of vacuum, and therefore, the degree of vacuum within the vacuum chamber in which the quadrupole mass filter is placed does not need to be so high as before. This is advantageous in that an inexpensive vacuum pump can be used.

However, decreasing the degree of vacuum increases the case where an observation target ion introduced into the space surrounded by the rod electrodes comes in contact with the gas and loses its energy to eventually fail to pass through. To address this problem, in the mass spectrometer according to the previously described aspect of the present invention, a direct electric field having a stepwise or linear slope in the direction of the passage of the ion may be formed within the space surrounded by the four rod electrodes, so as to accelerate the ion in a travelling direction of the ion by the effect of this electric field.

In order to create such a direct electric field, for example, each of the four rod electrodes may be formed by N segments arranged in the axial direction at predetermined intervals of space (where N is an integer equal to or greater than two), and the voltage generator may be configured to apply different direct voltages having stepwise potential differences to the N axially arranged segments of the rod electrodes. By this configuration, a direct electric field having a stepwise downward gradient in the axial direction, i.e. in the direction of the passage of the ions, can be formed within the space surrounded by the four rod electrodes, to make the ions move forward while being accelerated.

Each of the four rod electrodes may be a resistive element or a conductor coated with a resistive layer, and the voltage generator may be configured to respectively apply direct voltages having a predetermined potential difference to the two ends of the four rod electrodes. By this configuration, a direct electric field having an obliquely downward gradient in the axial direction, i.e. in the direction of the passage of the ions, can be formed within the space surrounded by the four rod electrodes, to make the ions move forward while being accelerated.

### Advantageous Effects of Invention

By the method for designing an ion optical element according to the present invention, it is possible to realize a linear ion trap which exhibits a high level of resolving power in the ion separation for the selection of a precursor ion (or for other purposes), while maintaining a high level of ion-trapping efficiency. It is also possible to realize a quadrupole mass filter which can selectively allow an ion having a specific m/z value or ions included within a specific m/z range as the target of the analysis to pass through with a high level of separating power even under the condition that the degree of vacuum is comparatively low.

By the mass spectrometer according to one aspect of the present invention, an ion having a target m/z can be retained with a high degree of purity within a linear ion trap, and a high-quality MSⁿ spectrum originating from the target ion can be acquired. By the mass spectrometer according to another aspect of the present invention, mass spectra can be acquired with a level of high mass-resolving power and sensitivity without using a high-performance vacuum pump.

### BRIEF DESCRIPTION OF DRAWINGS

FIG. 1 is a schematic configuration diagram of a mass spectrometer as one embodiment of the present invention.

FIG. 2 is a schematic cross-sectional view of the main rod electrodes of a linear ion trap in the mass spectrometer according to the present embodiment.

FIG. 3 is a schematic diagram of a direct-current potential distribution on the central axis C for trapping ions in the linear ion trap of the mass spectrometer according to the present embodiment.

FIGS. 4A-4C are diagrams showing examples of the resonance curve representing the relationship between the oscillation frequency and oscillation amplitude of an ion.

FIG. 5 is a graphic showing the result of a simulation of the relationship between the amplitude and the oscillation frequency of an ion when the shortest distance between the central axis and the rod electrodes was changed.

FIG. 6 is a graphic showing the result of a simulation of the relationship between the amplitude and the oscillation frequency of an ion when the shortest distance between the central axis and the rod electrodes was changed.

FIG. 7 is a table showing the ratios of the strengths of the octapole electric field and the dodecapole electric field to that of the quadrupole electric field, as well as the ratio of the strength of the octapole electric field to that of the dodecapole electric field in the six models shown in FIG. 5.

FIG. 8 is a table showing the ratios of the strengths of the octapole electric field and the dodecapole electric field to that of the quadrupole electric field, as well as the ratio of the strength of the octapole electric field to that of the dodecapole electric field in the six models shown in FIG. 6.

FIG. 9 is a diagram showing the relationship between the stability region and operating line of an ion in a common type of quadrupole mass filter.

FIG. 10 is a diagram showing one example of a broadband FNF signal whose frequency spectrum has a notch at a specific frequency.

FIG. 11 is a schematic configuration diagram of a mass spectrometer as a second embodiment of the present invention.

FIG. 12 is a schematic configuration diagram of a power source unit for applying voltages to a quadrupole mass filter in the mass spectrometer according to the second embodiment.

FIG. 13 is a schematic diagram of a direct-current potential distribution on the central axis of the quadrupole mass filter in the mass spectrometer according to the second embodiment.

FIG. 14 is a schematic diagram of the direct-current potential distribution on the central axis of a quadrupole mass filter in a mass spectrometer as still another embodiment of the present invention.

### DESCRIPTION OF EMBODIMENTS

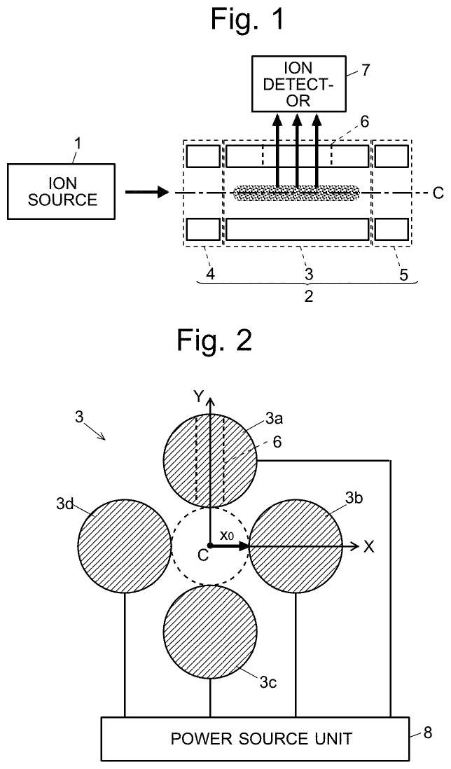

Initially, one embodiment of the method for designing an ion optical element according to the present invention and a mass spectrometer using a linear ion trap designed by the method is hereinafter described with reference to the attached drawings. FIG. 1 is a schematic configuration diagram of the mass spectrometer according to the present embodiment.

The mass spectrometer according to the present embodiment includes an ion source 1 for ionizing the components in a target sample, a linear ion trap 2, and an ion detector 7 for detecting ions ejected from the ion trap 2, which are all contained within a vacuum chamber (not shown). FIG. 2 is a schematic cross-sectional diagram of the main rod electrodes 3 cut at a section orthogonal to the central axis C in the linear ion trap 2.

The linear ion trap 2 includes four main rod electrodes 3 (3a-3d) arranged parallel to each other so as to surround the linear central axis C, as well as four entrance-side auxiliary rod electrodes 4 and four exit-side auxiliary rod electrodes 5 respectively located at both ends of the main rod electrodes 3 along the central axis C. The space surrounded by the four main rod electrodes 3a-3d is the ion-trapping area. The arrangement of the four entrance-side auxiliary rod electrodes 4 and four exit-side auxiliary rod electrodes 5 around the central axis C is identical to that of the main rod electrodes 3. The lengths of those auxiliary rod electrodes in the direction of the central axis C are shorter than that of the main rod electrodes 3. One main rod electrode 3a has an ion ejection opening 6. Ions trapped within the ion-trapping area are ejected through this ion ejection opening 6 in a direction substantially orthogonal to the central axis C. The ejected ions enter the ion detector 7 located on the outside of the opening 6.

The power source unit 8 applies a predetermined sinusoidal voltage or direct voltage, or both, to each of the rod electrode 3, 4 and 5 forming the linear ion trap 2. Specifically, when ions are to be trapped, the power source unit 8 applies a radio-frequency voltage A cos ωt to the two main rod electrodes 3a and 3c facing each other across the central axis C, as well as another radio-frequency voltage −A cos ωt with the reversed polarity to the other two main rod electrodes 3b and 3d. The frequency co is set according to the m/z value or m/z ranges of the ion or ions to be trapped. On the other hand, when unnecessary ions are to be removed from the ions trapped within the ion-trapping area, or when the trapped ions are to be ejected through the ion ejection opening 6 to the outside for detection, the power source unit 8 superposes, on the aforementioned radio-frequency voltages, an alternating voltage ±B cos Ωt with opposite polarities to the two main rod electrodes 3a and 3c, respectively. By making the frequency Ω of this alternating voltage equal to the oscillation frequency of the ion, the ions can be resonantly excited for the separation or ejection of the ions.

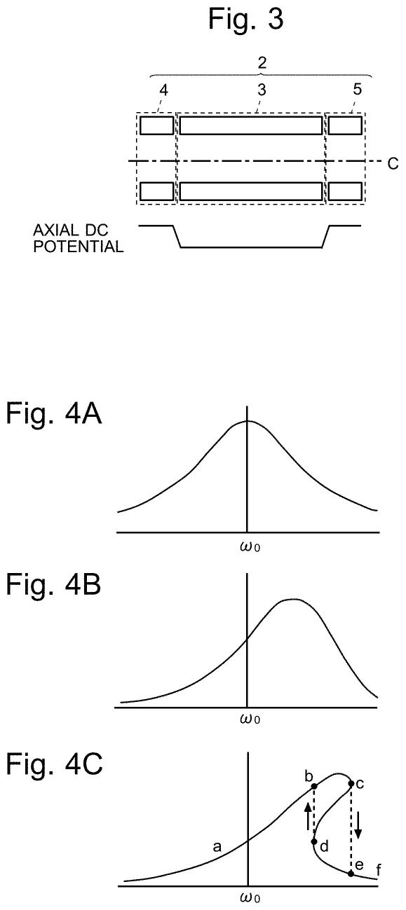

When ions are to be trapped, a direct voltage higher than the one applied the main rod electrodes 3 is applied to the entrance-side auxiliary rod electrodes 4 and the exit-side auxiliary rod electrodes 5 to create a direct-current potential as shown in FIG. 3 on the central axis C. The ions can be held by this potential within the space between the entrance-side auxiliary rod electrodes 4 and the exit-side auxiliary rod electrodes 5.

In an ideal linear ion trap, the portion facing the central axis C in the cross section of the main rod electrodes 3a-3d has a hyperbolic shape. All main rod electrodes 3a-3d have the same shortest distance from the central axis C (which equals the radius of the inscribed circle shown by the dashed line in FIG. 2). In this case, as is commonly known, the potential distribution ϕ on a plane orthogonal to the central axis C (X-Y plane) within the ion-trapping area surrounded by the four main rod electrodes 3a-3d can be generally expressed by the following equation (1):

ϕ(ρ,θ)=VΣ(ρ/x₀)ⁿ{Aₙ cos(nθ)+Bₙ sin(nθ)} (1)

where Σ is the sum from n=0 to n=∞. ρ is the distance from the origin (which is the position of the central axis C in the X-Y plane) to an observed point, ρ=√(x²+y²), where x and y are the positions on the X and Y axes, respectively. θ is the angle of the observed point from the X axis with the origin as the center. V is the applied voltage (amplitude). Aₙ is the multipole electric field coefficient. For example, A₂ is the quadrupole, A₃ is the hexapole, A₄ is the octapole, A₅ is the decapole, and A₆ is the dodecapole. Constant x₀ is equal to the radius of the inscribed circle in the main rod electrodes 3a-3d (if the electrode arrangement is symmetrical), or equal to ½ of the shortest distance between the two electrodes to which the alternating excitation voltage is applied (if the electrode arrangement is asymmetrical). This constant is used as the normalization constant.

If the shape and arrangement of the four main rod electrodes 3a-3d are symmetrical with respect to the Y axis, there is no term with n being an odd number in equation (1), and there are only the terms with n being an even number. In principle, the quadrupole field is the most dominant in the linear ion trap 2. The potential distribution of the quadrupole field is expressed by the following equation (2):

ϕ=(V/x₀²)A₂(x²−y²) (2)

The electric field created within the linear ion trap in the ideal state purely consists of this quadrupole field. If the shape and arrangement of the main rod electrodes 3a-3d are made to deviate from the ideal state, higher-order multipole electric fields are generated. For example, the potential distribution of the octapole electric field is expressed by the following equation (3):

ϕ=VA₄{(x⁴−6x²y²+y⁴)/x₀} (3)

The potential distribution of the dodecapole electric field is expressed by the following equation (4):

ϕ=VA₆{(x⁶−15x⁴y²+15x²y⁴−y⁶)/x₀⁶} (4)

For example, consider the case where the octapole electric field is superposed on the quadrupole electric field. In this case, the potential distribution within the linear ion trap 2 is given by the following equation (5):

ϕ=(V/x₀²)A₂(x²−y²)+(V/x₀⁴)A₄(x⁴−6x²y²+y⁴) (5)

The ion confinement potential ϕ_{eff} is expressed by the following equation (6):

ϕ_{eff}=(eEz²)/(4 mΩ²)={(qA₂²V)/(4x₀²)}x²+{(qA₂A₄V)(x₀⁴)}x⁴ (6)

If an ion is trapped by this potential ϕ_{eff} and made to oscillate, the equation of motion of the ion is given by the following equation (7):

x+{(eqA₂²V)/(2x₀²)}x=−{(4eqA₂A₄V)/(x₀⁴)}x³ (7)

Equation (7) has the term of x³ on the right side. This is an equation of non-linear oscillation, called the Duffing equation. The solution to this equation is commonly known. As is known from Non-Patent Literature 1 or other related documents, if a forced oscillation due to a forced oscillation electric field is added to an oscillation based on the aforementioned equation, the resonance curve obtained by plotting the oscillation amplitude against the forced oscillation frequency will be as shown in FIG. 4C in some cases. Now, suppose that the resonance curve has a shape as shown in FIG. 4C. As the frequency changes in the decreasing direction (in the leftward direction along the horizontal axis in FIGS. 4A-4C), the amplitude increases along the slope “f” and suddenly changes to point b at the position of point d. Conversely, when the frequency changes in the increasing direction, the amplitude increases along the slope “a” with the changing frequency and suddenly changes to point e at the position of point c. Such a discontinuous change is the “jumping phenomenon”, which will be described later.

In the case of a normal resonance curve as shown in FIG. 4A, a displacement Δω of the resonance frequency is expressed by the following equation (8):

Δω=(A₄/A₂){P²/(x₀²)}ω₀ (8)

where P is the amplitude value of the oscillation. Equation (8) means that the resonance frequency shifts by a ratio of A₄/A₂ when the amplitude P is x₀.

As described in the Japanese Patent Application No. 2016-080038, which is a prior application by the applicant, the present inventor conducted a detailed simulation of the relationship between the amplitude and oscillation frequency of an ion in a three-dimensional quadrupole ion trap under the condition that a plurality of voltages which respectively superpose octapole, dodecapole, hexadecapole and other higher-order multipole electric fields are applied to a pair of endcap electrodes creating a quadrupole electric field. As a result, the following facts were revealed.

(1) When only an octapole electric field is superposed on the quadrupole electric field, the slope of the peak of the resonance curve on the high-frequency side becomes steep, but the slope of the peak on the low-frequency side becomes gentle.

(2) When an octapole electric field is superposed on the quadrupole electric field, and a dodecapole electric field with the opposite polarity to the octapole electric field is additionally superposed, the peak shift of the resonance curve can be cancelled, and the slope on the low-frequency side can be made to be steeper by the effect of the jumping phenomenon while maintaining the steepness of the slope on the high-frequency side.

As noted earlier, the steeper the slope of the resonance curve is, the higher the resolving power of the ion separation or ion ejection is. Accordingly, the fact (2) means that the resolving power of the ion separation or ion ejection can be improved on both the low-frequency and high-frequency sides while maintaining the ion-trapping efficiency at a high level. Since the operation principle of the linear ion trap is basically the same as that of the three-dimensional quadrupole ion trap, the previously described finding can also be applied to the linear ion trap. However, it is expected that optimum parameters will be considerably different due to the difference in their electrode structures.

The simplest method for increasing the ratio of the multipole electric fields superposed on the quadrupole electric field in the linear ion trap is to make the arrangement of the four rod electrodes 3a-3d deviate from the ideal state. Based on this idea, the inventor has explored the conditions under which the jumping phenomenon due to the non-linear oscillation occurs on both the high-frequency and low-frequency sides of the resonance curve in the linear ion trap, as shown in FIG. 2, by shifting the two main rod electrodes 3b and 3d on the X axis inward from their respective ideal positions by Δdx as well as the two main rod electrodes 3a and 3c on the Y axis inward from their respective ideal positions by Δdy (i.e. by breaking the symmetry with respect to the central axis C) so that a positive octapole term and a negative dodecapole term will appear.

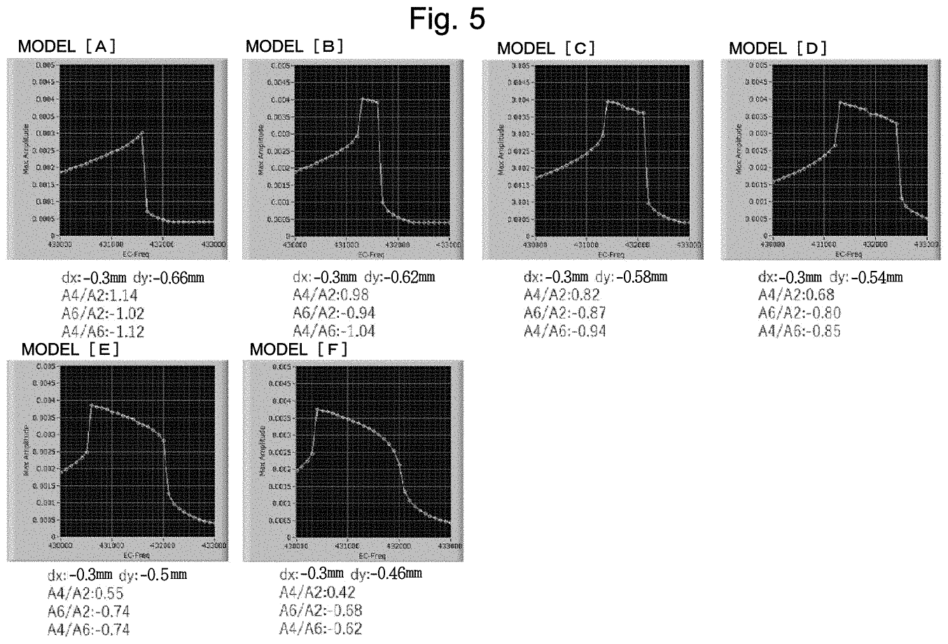

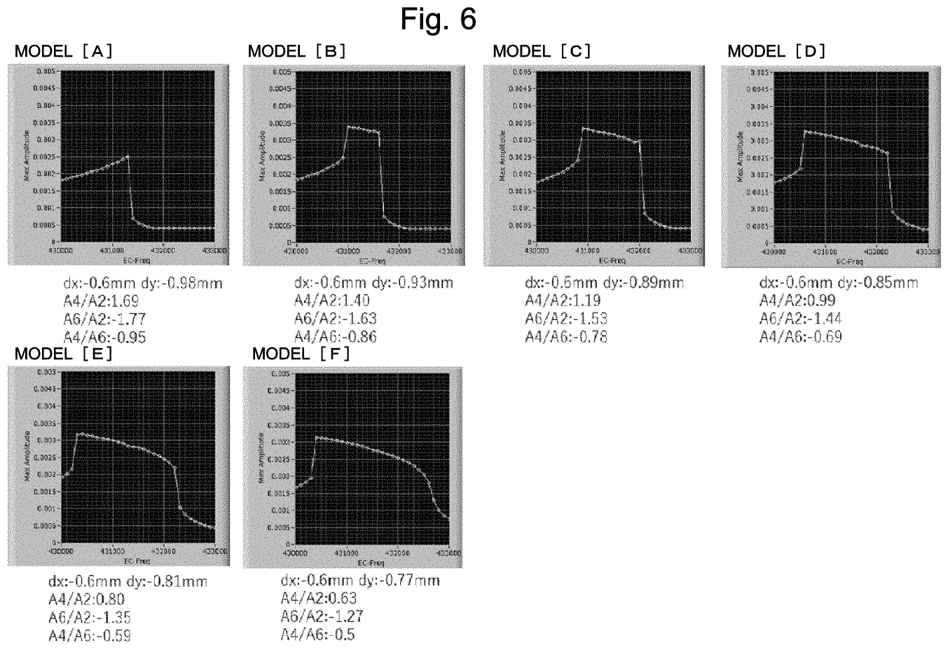

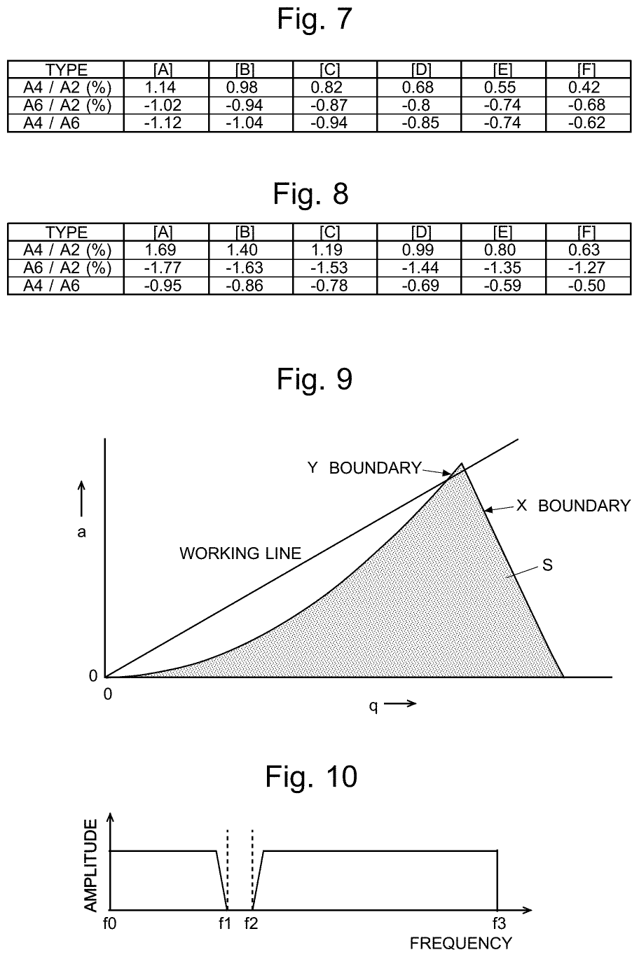

The resonance curve of an ion was calculated under the condition that the amount of shift Δdy of the main rod electrodes 3a and 3c was varied while the amount of shift Δdx of the main rod electrodes 3b and 3d was fixed at −0.3 mm. The results are shown in FIG. 5. Furthermore, the resonance curve of an ion was also calculated under the condition that the amount of shift Δdy of the main rod electrodes 3a and 3c was varied while the amount of shift Δdx of the main rod electrodes 3b and 3d was fixed at −0.6 mm. The results are shown in FIG. 6. In both cases, the two-dimensional surface charge method was used for the calculation. FIGS. 7 and 8 are tables showing the ratios of the strengths of the octapole electric field and the dodecapole electric field to that of the quadrupole electric field, as well as the ratio of the strength of the octapole electric field to that of the dodecapole electric field in the models shown in FIGS. 5 and 6, respectively. The unit of “A₄/A₂” and “A₆/A₂” is percentage.

As can be understood from FIGS. 7 and 8, the ratio of the octapole electric field to the quadrupole electric field (A₄/A₂) sequentially decreases from model [A] to model [F], while the component of the dodecapole electric field relatively increases. FIGS. 5 and 6 show that, in both cases, the slope of the resonance curve observed in models [B], [C], [D] and [E] is almost vertical on both the high-frequency and low-frequency sides. On the other hand, the slope in model [A] lacks steepness on the low-frequency side, while the slope in model [F] conversely lacks steepness on the high-frequency side. The steepness of the slope of the resonance curve in models [B] to [E] is due to the jumping phenomenon associated with the non-linear oscillation. In this state, the oscillation amplitude at the peak top hits the ceiling; i.e. the amplitude is suppressed. This means that the ion-trapping efficiency is also high. In summary, under the conditions of models [B] to [E], the linear ion trap can maintain a high level of trapping efficiency for an ion that should be retained within the ion trap, while exhibiting a high level of separating power for exciting or ejecting ions that should be excited or ejected.

According to the results shown in FIGS. 5 and 6, in the case of a linear ion trap, the previously mentioned conditions will be satisfied if the following conditions are met: both the absolute value of the ratio of the octapole electric field component to the quadrupole electric field component, and that of the ratio of the dodecapole electric field component to the quadrupole electric field component, are equal to or greater than 0.005; and the absolute value of the ratio of the octapole electric field component to the dodecapole electric field component is within a range from 0.5 to 1.4. Therefore, in the mass spectrometer according to the present embodiment, the arrangement of the four main rod electrodes 3a-3d is made to deviate from the ideal state so as to satisfy those conditions. By such a design, only an ion having a m/z value to be detected can be ejected from the linear ion trap 2 with a high level of separating power and detected while a high level of ion-trapping efficiency is maintained.

The previously described embodiment is concerned with the case of designing a linear ion trap by the designing method according to the present invention. A different type of ion optical element having four rod electrodes can similarly be designed. Hereinafter described is a mass spectrometer in which a quadrupole mass filter designed by the designing method according to the present invention is used as a mass spectrometer.

As is commonly known, in a common type of quadrupole mass filter, a voltage +U+V cos ωt is applied to a pair of rod electrodes facing each other among the four rod electrodes, while a voltage −U−V cos ωt is applied to the other pair of rod electrodes. The relationship between U and V is appropriately determined to selectively allow an ion having a specific m/z value to pass through. A condition under which an ion can pass through a quadrupole mass filter in a stable manner without being dispersed is known as the solution to the Mathieu equation. This solution is indicated by the substantially triangular stability region S in FIG. 9. The operating line for driving the quadrupole mass filter (the relationship between U and V) is a straight line passing through the origin in the figure. In order to allow an ion having a specific m/z value to pass through with a high level of separating power, the quadrupole mass filter should preferably be operated under the condition that the operating line traverses the stability region S at a position which is as close to the apex of the region S as possible, as shown in FIG. 9.

A quadrupole mass filter is normally placed within a vacuum chamber maintained at a high degree of vacuum. If the degree of vacuum is lowered and the influence of the gas collision with the ion becomes nonnegligible, the boundary of the stability region S near the apex becomes unstable (in other words, the boundary can considerably vary). Therefore, in order to use a common type of quadrupole mass filter under the condition of a comparatively low degree of vacuum, it is necessary to decrease the gradient of the operating line and increase the width of the portion of the stability region S traversed by the operating line so that the operating line will assuredly traverse the stability region S. However, this means a decrease in the mass-resolving power. That is to say, for a quadrupole mass filter to achieve a certain level of mass-resolving power, there is the restriction that the quadrupole mass filter must be used at a high degree of vacuum.

In the linear ion trap according to the previously described embodiment, an ion having a specific m/z value can be oscillated in a direction orthogonal to the central axis C by applying an alternating voltage having a single specific frequency corresponding to the specific m/z value to a pair of main rod electrodes. Since the resonance curve takes a shape having a steep slope on both the high-frequency and low-frequency sides, a high level of mass-separating power will be achieved. Conversely, if a broadband voltage having a frequency spectrum with a notch at a specific frequency as shown in FIG. 10 is applied to a pair of main rod electrodes, all ions can be excited except for an ion having a specific m/z value corresponding to the frequency of the notch. For the generation of such a broadband signal, a method disclosed in the already mentioned Patent Literature 4 can be used, in which the signal is generated by superposing a plurality of sinusoidal signals ranging from the lowest frequency to the highest frequency at specific intervals of frequency.

So, in the quadrupole mass filter according to the present embodiment, the arrangement of the four rod electrodes are intentionally made to deviate from the theoretical state to generate higher-order multipole components. Additionally, a broadband alternating voltage for excitation having a notch at a specific frequency is applied to a pair of rod electrodes so that only an ion having a specific m/z value corresponding to that frequency is allowed to pass through.

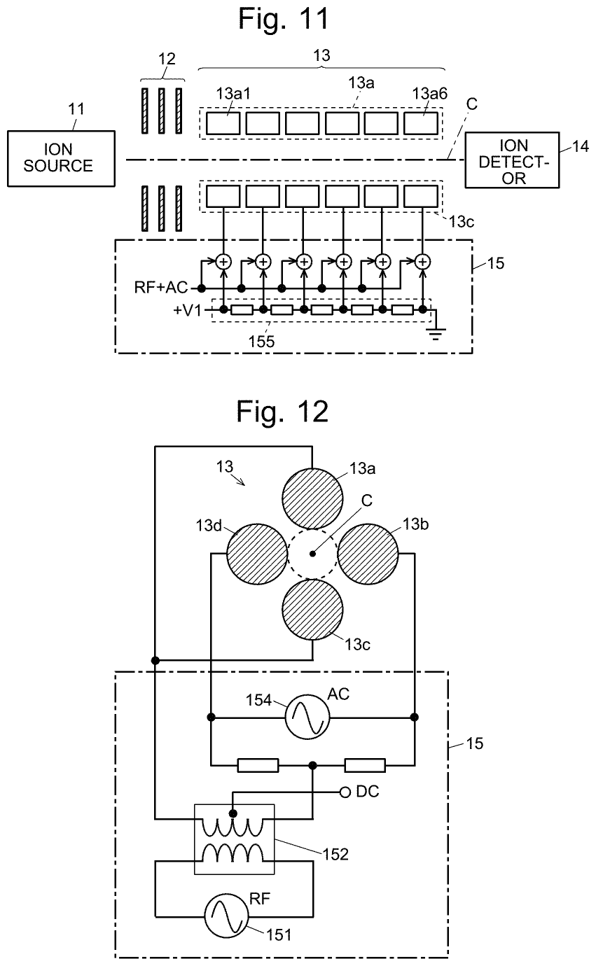

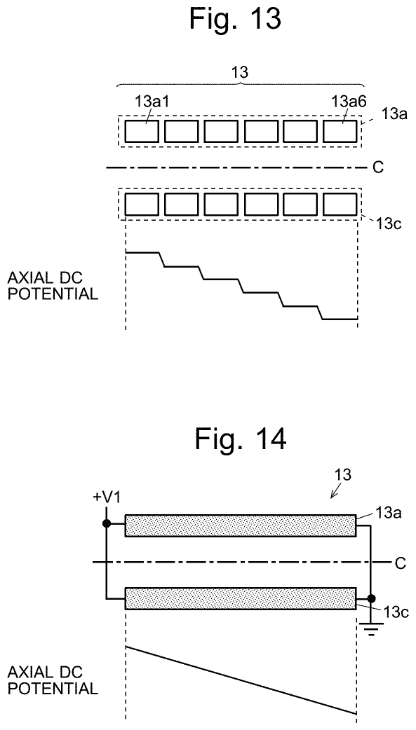

FIG. 11 is a schematic configuration diagram of the mass spectrometer according to the present embodiment. FIG. 12 is a schematic configuration diagram of a power source unit for applying voltages to a quadrupole mass filter. FIG. 13 is a schematic diagram of a direct-current potential distribution on the central axis of the quadrupole mass filter.

Ions originating from sample components generated within an ion source 11 are introduced through an ion lens 12 into a quadrupole mass filter 13. An ion having a specific m/z value or ions included within a specific m/z range which have passed through the quadrupole mass filter 13 arrive at and detected by an ion detector 14. The quadrupole mass filter 13 is formed by four rod electrodes 13a, 13b, 13c and 13d arranged around the central axis C. Each of those rod electrodes 13a, 13b, 13c and 13d is divided into segments which are arranged along the central axis C with a predetermined distance from each other. This configuration is adopted to form a direct-current potential having a gradient along the central axis C.

A power source unit 15 applies voltages to four rod electrodes 13a, 13b, 13c and 13d, respectively. This unit includes a radio-frequency power source 151 for generating a radio-frequency voltage for trapping ions, a transformer 152 for adding the radio-frequency voltage and a direct voltage, as well as an alternating power source 154 for generating an alternating voltage for excitation. A radio-frequency voltage for trapping ions generated by the radio-frequency power source 151 is applied through the transformer 152 to a pair of rod electrodes 13a and 13c, while another radio-frequency voltage with the opposite polarity is applied to the other pair of rod electrodes 13b and 13d. The radio-frequency voltage is equally applied to all segments of each rod electrode arranged along the central axis C. Due to the effect of the electric field created by the radio-frequency voltages, ions which have entered the quadrupole mass filter 13 are trapped within the inner space of this mass filter.

On the other hand, the alternating voltage for excitation generated by the alternating power source 154 is applied only between the pair of rod electrodes 13b and 13d. This alternating voltage is the aforementioned broadband voltage having a notch at a specific frequency value or frequency range. Similar to the radio-frequency voltage, this alternating voltage is also equally applied to all segments of each rod electrode arranged along the central axis C. Furthermore, as shown in FIG. 11, a series of direct voltages whose voltage values are decreased in a stepwise manner by resistive division are also respectively applied to the segments of each rod electrode arranged along the central axis C. As a result, the direct-current potential distribution along the central axis C takes the shape of a stepwise downward gradient in the travelling direction of the ions, as shown in FIG. 13 (if the ions are positive ions).

Due to the effect of the electric field created by the alternating voltage and superposed on the ion-trapping electric field, all ions trapped in the previously described manner are excited and made to significantly oscillate in the direction orthogonal to the central axis C except for an ion having a specific m/z value or ions included within a specific m/z range. Meanwhile, due to the previously described direct-current potential, the ions also receive kinetic energy in their travelling direction and move forward. In the middle of their travel, ions which have been excited in the previously described manner are removed by coming in contact with the rod electrodes or being discharged through the gap between the rod electrodes to the outside. Thus, only the ions which have not been excited continue their travel in the trapped state, pass through the quadrupole mass filter 13, and reach the ion detector 14.

Thus, the present mass spectrometer can selectively detect an ion or ions having an m/z value or included within an m/z range corresponding to the frequency of the notch in the frequency spectrum of the alternating voltage generated by the alternating power source 154. By continuously varying either the central frequency of the notch in this alternating voltage or the radio-frequency voltage, the m/z value of the ion passing through the quadrupole mass filter 13 can be continuously changed. By recording the detection signal synchronously with this operation, a mass spectrum can be obtained.

Since the previously described jumping phenomenon does not depend on the degree of vacuum, a mass separation with a high level of resolving power can be achieved even under the condition that the degree of vacuum is low. However, a low degree of vacuum means that ions are more likely to collide with the gas and lose their kinetic energy, so that their passing efficiency will be lower. By comparison, the mass spectrometer according to the present embodiment gives kinetic energy to the ions by creating a downward gradient of the direct-current potential in the travelling direction of the ions. Therefore, even if the target ion collides with the gas, the ion can be guided to the ion detector 14, and a high level of passing efficiency can be achieved. Thus, both a high level of ion selectivity and a high level of detection sensitivity can be realized even under the condition that the degree of vacuum is low.

The method for creating the direct-current potential distribution along the central axis C is not limited to the previously described ones. Other appropriate methods which are commonly known may also be used. For example, the four rod electrodes themselves may be made of resistive elements, or the rod electrodes made of an electric conductor (e.g. metal) may be coated with a resistive layer, and a direct-current potential difference may be given between the two ends of the rod electrodes, whereby an electric field showing a direct-current potential distribution with a linear downward gradient can be created, as shown in FIG. 14.

The previously described embodiments are examples of the present invention, and any change, modification or addition appropriately made within the spirit of the present invention will naturally fall within the scope of claims of the present application.

### REFERENCE SIGNS LIST

1, 11 . . . Ion Source
2 . . . Linear Ion Trap
3, 3a, 3b, 3c, 3d, 13a, 13b, 13c, 13d . . . Main Rod Electrode
4 . . . Entrance-Side Auxiliary Rod Electrode
5 . . . Exit-Side Auxiliary Rod Electrode
6 . . . Ion Ejection Opening
7, 14 . . . Ion Detector
8, 15 . . . Power Source Unit
12 . . . Ion Lens
13 . . . Quadrupole Mass Filter
151 . . . Radio-Frequency Power Source
152 . . . Transformer
154 . . . Alternating Power Source
C . . . Central Axis

1. A method for designing an ion optical element including four rod electrodes arranged substantially parallel to a linear axis so as to surround the axis, the ion optical element allowing voltages to be respectively applied to the four rod electrodes to create a quadrupole electric field and a multipole electric field whose order is higher than the quadrupole electric field within a space surrounded by the rod electrodes, to trap ions within the space and subsequently perform an ion-separating operation for retaining an ion having a specific mass-to-charge ratio or ions included within a specific mass-to-charge-ratio range among the trapped ions by removing the other ions, or to perform an ion-separating operation for selectively allowing an ion having a specific mass-to-charge ratio or ions included within a specific mass-to-charge-ratio range to pass through among ions entering the space, wherein:
a shape and arrangement of the four rod electrodes are determined so that a polarity of a ratio of a strength of an octapole electric field to a strength of a quadrupole electric field is different from a polarity of a ratio of a strength of an dodecapole electric field to the strength of the quadrupole electric field, where an absolute value of each of the ratios is equal to or greater than 0.005, and an absolute value of a ratio of the strength of the octapole electric field to the strength of the dodecapole electric field is within a range from 0.5 to 1.4.

2. The method for designing an ion optical element according to claim 1, wherein:
the octapole electric field and the dodecapole electric field are generated and superposed on the quadrupole electric field by designing the four rod electrodes so that each of the four rod electrodes has a circular cross section or includes a portion having an arc-shaped cross section facing the axis, the four rod electrodes are grouped into two rod-electrode pairs each of which includes two rod electrodes facing each other across the axis, and a shortest distance between the axis and the two rod electrodes included in one rod-electrode pair is made to differ from a shortest distance between the axis and the two rod electrodes included in the other rod-electrode pair.

3. A mass spectrometer including: an ion source configured to generate ions originating from a sample; a linear ion trap including four rod electrodes arranged substantially parallel to a linear axis so as to surround the axis, the linear ion trap allowing voltages to be respectively applied to the four rod electrodes to create a quadrupole electric field and a multipole electric field whose order is higher than the quadrupole electric field within a space surrounded by the rod electrodes, to trap ions within the space; and an ion detector section configured to detect an ion ejected from the linear ion trap, where the mass spectrometer is configured to trap ions within the space and subsequently perform an ion-separating operation for maintaining an ion having a specific mass-to-charge ratio or ions included within a specific mass-to-charge-ratio range among the trapped ions by removing the other ions, wherein:
a shape and arrangement of the four rod electrodes in the linear ion trap are determined so that a polarity of a ratio of a strength of an octapole electric field to a strength of a quadrupole electric field is different from a polarity of a ratio of a strength of an dodecapole electric field to the strength of the quadrupole electric field, an absolute value of each of the ratios is equal to or greater than 0.005, and an absolute value of a ratio of the strength of the octapole electric field to the strength of the dodecapole electric field is within a range from 0.5 to 1.4.

4. A mass spectrometer including: an ion source configured to generate ions originating from a sample; a quadrupole mass filter configured to selectively allow an ion having a specific mass-to-charge ratio or ions included within a specific mass-to-charge-ratio range to pass through; and an ion detector section configured to detect an ion exiting from the quadrupole mass filter, wherein:
the quadrupole mass filter includes four rod electrodes arranged substantially parallel to a linear axis so as to surround the axis, where a shape and arrangement of the four rod electrodes surrounding the axis are determined so that a polarity of a ratio of a strength of an octapole electric field to a strength of a quadrupole electric field is different from a polarity of a ratio of a strength of an dodecapole electric field to the strength of the quadrupole electric field, an absolute value of each of the ratios is equal to or greater than 0.005, and an absolute value of a ratio of the strength of the octapole electric field to the strength of the dodecapole electric field is within a range from 0.5 to 1.4; and
the mass spectrometer further comprises a voltage generator configured to apply, to each of the four rod electrodes, a radio-frequency voltage having a frequency component corresponding to a mass-to-charge ratio or mass-to-charge-ratio range of an ion or ions which should be allowed to pass through the quadrupole mass filter.

5. The mass spectrometer according to claim 4, wherein:
each of the four rod electrodes is formed by N segments arranged in an axial direction at predetermined intervals of space (where N is an integer equal to or greater than two); and
the voltage generator is configured to apply different direct voltages having stepwise potential differences to the N axially arranged segments of the rod electrodes.

6. The mass spectrometer according to claim 4, wherein:
each of the four rod electrodes is a resistive element or a conductor coated with a resistive layer; and
the voltage generator is configured to respectively apply direct voltages having a predetermined potential difference to two ends of the four rod electrodes.
